(19) United States
(12) Patent Application Publication
(10) Pub. No.: US 2009/0100681 A1
(43) Pub. Date: Apr. 23, 2009

(54) COAXIAL CABLE STRIPPING TOOL WITH ADJUSTABLE STRIP STOP

(75) Inventor: Andrew J. Tarpill, East Haddam, CT (US)

Correspondence Address: LAW OFFICE OF DELIO & PETERSON, LLC., 121 WHITNEY AVENUE, 3RD FLLOR, NEW HAVEN, CT, 06510, US

(73) Assignee: CAPEWELL COMPONENTS COMPANY, LLC, Cromwell, CT (US)

(21) Appl. No.: 11/875,179

(22) Filed: Oct. 19, 2007

(51) Int. Cl. H02G 1/12

(52) U.S. Cl. 30/90.1

(57) ABSTRACT

An adjustable coaxial cable stripping tool for preparing an end of a coaxial cable for attachment to a connector includes first and second mechanisms located at opposite ends of the tool. The first cutting mechanism uses a pair of jaws and a planar cutting blade mounted in a replaceable blade cartridge to cut through the outer conductor and inner insulation to the inner conductor. The second cutting mechanism uses a double edged cutting blade and an adjustable stop that contacts the cut made by the first cutting mechanism to control the distance that the outer insulation is removed beyond the first cut. A third cutter is optionally provided to form a bevel on the end of the inner conductor.

### BACKGROUND OF THE INVENTION

1. Field of the Invention

This invention relates to tools used to remove insulation from around the inner and outer conductors at the end of a coaxial cable prior to attaching a connector. More specifically, the invention relates to coaxial cable stripping tools that are adjustable to change the distance that insulation is removed from the end of the cable and which include multiple blades on a single integrated tool to perform all the stripping operations required to prepare the cable for connector attachment.

2. Description of Related Art

Coaxial cables are widely used to distribute a variety of high frequency signals, such as video signals and data communications, to multiple reception points. Coaxial cables include an inner conductor surrounded by an inner layer of insulation and an outer conductor surrounded by an outer layer of insulation. The inner conductor is typically a solid conductive wire while the outer conductor is often a conductive wire braid or foil. To install a connector on the end of a coaxial cable of this type, it is necessary to expose a desired length of the two conductors at the end of the cable by removing the surrounding layers of insulation.

The inner and outer insulating layers perform different functions and are usually formed of different types of insulating material. The outer insulation serves to mechanically cover and protect the cable from abrasion and may be a relatively tough plastic coating that is difficult to cut. The inner insulating material, however, is protected within the outer conductor of the cable and its electrical properties strongly affect cable performance. Thus, the inner insulation may be a much different material from the outer insulation and is often relatively easy to cut.

The cutting blade exposing the inner conductor must penetrate the outer conductor as well as the inner insulation, and in the conventional preparation sequence, it must also penetrate the outer insulation. The cutting blade exposing the outer conductor only needs to remove a portion of the outer insulation. As a result of the differences between the inner and outer layers of insulation and the cuts that must be made, cutting blades with different shapes and cutting edges have been developed to optimally make the required cuts.

A knife-like planar cutting blade is often used to cut through the insulating layers and the outer conductor to expose the inner conductor. This type of planar blade can penetrate the tough outer insulating layer as well as foil or braid forming the outer conductor. It also cuts foam and other soft inner insulating layers without tearing to produce a clean cut surface. Because the outer surface of the inner conductor is usually very smooth and the inner insulation is often relatively soft, there is low adhesion between the inner insulating layer and the inner conductor. This allows the waste material to easily slide off the inner conductor at the end of the cable once the planar blade has made its cut.

Planar blades, however, are not as suitable for removing only the outer insulation. Although a planar blade can easily cut the outer insulation, the waste portion of the outer insulation may be difficult to remove due to the large contact area with the outer conductor and/or the better adhesion it has with conductive foil or braid forming the outer conductor. To address this difficulty, a double-edged blade in which two blade edges intersect at a corner is often used to spirally shave off the outer insulation. One edge of the blade tangentially shaves and separates the outer insulation from the outer surface of the outer conductor. The other edge cuts the shaved waste material from the remaining outer insulation. A blade of this type can be seen in U.S. Pat. No. 3,398,610.

Typically, these two different types of blades have been mounted on separate tools that are used sequentially to make the cuts required to expose the inner and outer conductors to different distances from the end of the cable. The use of two separate tools, however, is time consuming and requires that each tool be located before it can be used and stored after use.

Integrated multiple blade tools have also been developed that can make all the necessary cuts to prepare the end of some types of coaxial cables. Examples include U.S. Pat. Nos. 5,036,734 and 5,713,132. These integrated tools use two planar cutting blades to make the two cuts and are not adjustable. U.S. Pat. No. 6,128,976 discloses a non-adjustable coaxial cable stripping tool having a replaceable blade cartridge containing two spaced-apart planar stripping blades.

There exists a need for an integrated stripping tool that is adjustable to vary the location of the two cuts relative to each other and/or relative to the end of the cable. Existing integrated stripping tools have not been adjustable. An adjustable design permits the cable to be stripped for attachment of different types of coaxial cable connectors and allows the tool to be adjusted for wear.

### SUMMARY OF THE INVENTION

Bearing in mind the problems and deficiencies of the prior art, it is therefore an object of the present invention to provide an integrated coaxial cable stripping tool with two cutting mechanisms having differently shaped cutting blades that efficiently remove the inner and outer insulating layers as needed to prepare the end of the cable for connector attachment.

It is another object of the present invention to provide to provide a coaxial cable stripping tool that is adjustable.

It is a further object of the present invention to provide a coaxial cable stripping tool having removable and replaceable blades for stripping the coaxial cable.

Still other objects and advantages of the invention will in part be obvious and will in part be apparent from the specification.

The above and other objects, which will be apparent to those skilled in the art, are achieved in the present invention which is directed to a coaxial cable stripping tool for preparing an end of a coaxial cable for attachment to a connector. The coaxial cable to be prepared includes an outer conductor covered with an outer insulating layer and an inner conductor separated from the outer conductor by an inner insulating layer. The coaxial cable stripping tool includes a first cutting mechanism for cutting to the inner conductor located at a first end of the tool and a second cutting mechanism for cutting to the outer conductor at a second end of the tool.

The first cutting mechanism includes first and second jaw members connected together by a pivot to form a jaw set for receiving the coaxial cable therebetween. The first jaw member and second jaw member are biased towards each other and are movable with respect to each other about the pivot between an open position to receive the coaxial cable and a closed position to cut the coaxial cable.

A planar cutting blade is mounted to one of the jaw members for cutting through the inner insulating layer to the inner conductor to produce a cut surface on the inner insulating layer perpendicular to the coaxial cable. The planar cutting blade is most preferably mounted in a replaceable blade cartridge.

The second cutting mechanism includes a cable-receiving opening for receiving the coaxial cable, and an adjustable stop having a stop surface for contacting the cut surface on the inner insulating layer produced by the first cutting mechanism. The adjustable stop is axially movable relative to the cable-receiving opening.

A double-edged cutting blade is secured to the second cutting mechanism and projects at an angle into the cable-receiving opening. The double-edged cutting blade spirally cuts into and removes the outer insulating layer from the coaxial cable when the tool is rotated relative to the cable. The stop surface contacts the cut surface on the inner insulating layer when the outer insulating layer has been removed from the end of the coaxial cable to a desired adjustable distance.

In one aspect of the invention, the blade is mounted in a replaceable blade cartridge that snaps into a first jaw member with a dovetail-shaped connection. In another aspect of the invention, the coaxial cable stripping tool further includes an inner conductor cutter for applying a bevel and removing sharp edges from the end of the inner conductor.

The coaxial cable stripping tool is preferably arranged so that the first and second cutting mechanisms and the inner conductor cutter all receive the coaxial cable from parallel directions.

In still another aspect of the invention, the inner conductor cutter includes a conical opening for receiving an exposed end of the inner conductor and is mounted between the first and second cutting mechanisms.

In another aspect of the invention, the cable-receiving opening in the second cutting mechanism includes an open end for receiving the coaxial cable and a threaded end for receiving the adjustable stop. The adjustable stop includes a threaded end engaging the cable-receiving opening and a knurled end for rotating the adjustable stop to vary the distance between the stop surface and the double-edged cutting blade.

The jaw set of the first cutting mechanism preferably opens perpendicular to the coaxial cable allowing the planar cutting blade to be positioned at any location along the coaxial cable and the second cutting mechanism is open opposite to the cable-receiving opening to allow the inner conductor to extend through the second cutting mechanism as the double-edged cutting spirally removes the outer insulation.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a left side view of a coaxial cable stripping tool according to the present invention.

FIG. 2 is a top plan view of the coaxial cable stripping tool according to the present invention shown in FIG. 1.

FIG. 3 is a left side view of a blade cartridge containing a planar blade and removed from the coaxial cable stripping tool according to the present invention shown in FIG. 1.

FIG. 4 is a bottom view of the blade cartridge shown in FIG. 3.

FIG. 5 is a cross sectional view taken along the line 5-5 in FIG. 3 showing the blade cartridge of FIG. 3.

FIG. 6 shows a double-edged replaceable cutting blade according to the present invention.

### DESCRIPTION OF THE PREFERRED EMBODIMENT(S)

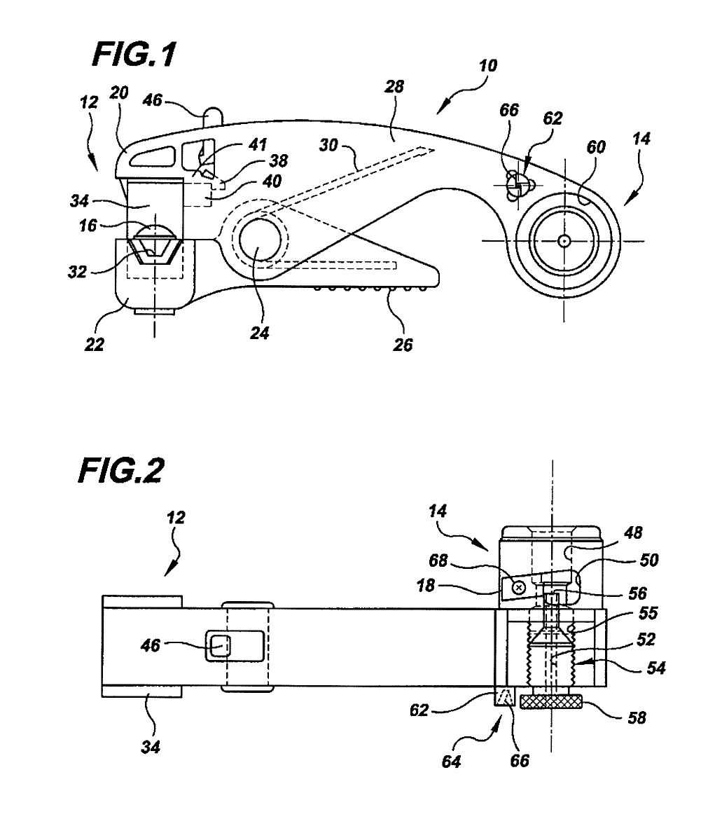

In describing the preferred embodiment of the present invention, reference will be made herein to FIGS. 1-6 of the drawings in which like numerals refer to like features of the invention.

Referring to FIGS. 1 and 2, the present invention is directed to a coaxial cable stripping tool 10 having a first cutting mechanism 12 at one end of the tool and a second cutting mechanism 14 at the opposite end of the tool. The first cutting mechanism 12 uses a knife-like planar blade 16 to cut through surrounding layers to the inner conductor. The second cutting mechanism 14 uses a double-edged cutting blade 18 (see FIGS. 2 and 6) that removes the outer insulating layer to expose the outer conductor.

The first cutting mechanism 12 includes a first jaw member 20 and a second jaw member 22 pivotally connected to the first jaw member with pivot 24. The first and second jaw members of the first cutting mechanism form a jaw set that pivots between open and closed positions by operating a pair of corresponding handles 26, 28. As the handles are squeezed, handle 26 moves towards handle 28, torsion spring 30 is compressed, and the jaw set opens. As pressure is released on the handles, the jaw set pivots closed under the influence of torsion spring 30.

When the jaws are open, the first cutting mechanism can be placed onto a coaxial cable at a desired position with the cable resting in the V-shaped guide 32 formed in jaw 22. When the handles are released, planar blade 16 penetrates through the outer insulating layer, the outer conductor and inner insulating layer and moves into tangential contact with the outer surface of the inner conductor. As the blade 16 reaches tangential contact with the outer surface of the inner conductor, the outside of the coaxial cable contacts the blade cartridge 34 holding the blade 16. This limits the depth of the cut made by blade 16.

The entire tool 10 is then rotated around the coaxial cable and the planar blade 16 produces a cut surface on the inner insulating layer that is perpendicular to the coaxial cable. The portion of the outer insulating layer, the outer conductor, and the inner insulating layer closest to the end of the coaxial cable can then be pulled off the end of the cable exposing the inner conductor from the location of the cut surface to the end of the cable.

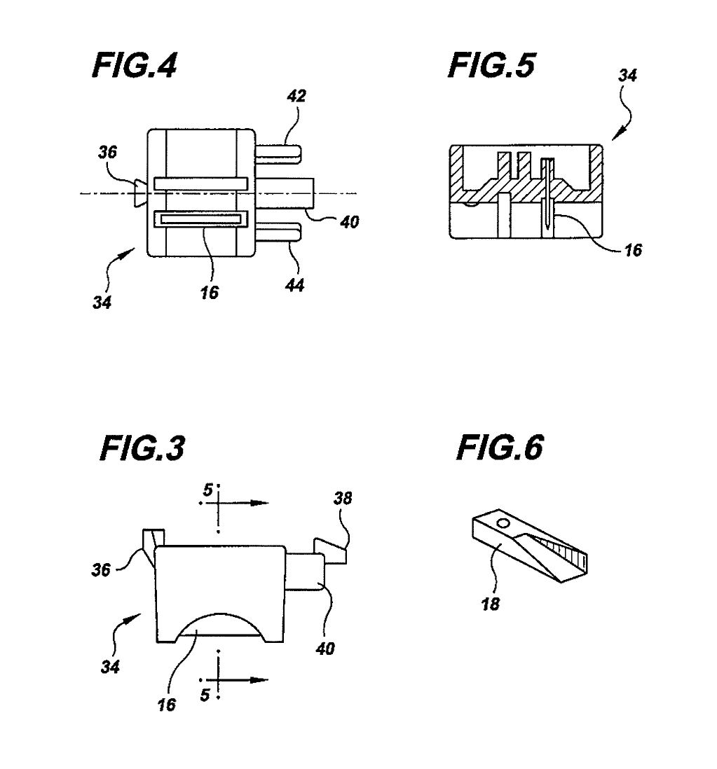

The planar cutting blade 16 is preferably replaceable, although it may be fixed. In the preferred design the cutting blade 16 is mounted in a removable blade cartridge 34 (see FIGS. 3-5) that snaps into the front of the first jaw 20. The blade cartridge 34 is held in place at the front of the first jaw 20 by a dovetail connection 36, snap connector 38 mounted on a spring arm 40 and a pair of support guides 42, 44 that extend into the jaw 20.

The support guides 42, 44 extend into the back of the jaw 20 with the snap connector 38 on spring arm 40. To install the blade cartridge 34, the jaws are opened, the guides 42 and 44 are aligned with corresponding openings in the jaw, the dovetail connection 36 is aligned with a correspondingly shaped dovetail opening in the front of the jaw and the cartridge is pushed towards the back of the tool. As the blade cartridge slides in, the snap connector 38 rides down and snaps under lip 41 (see FIG. 1) inside the tool. The replaceable blade cartridge is held in place without separate fasteners and merely snaps into position.

To release the cartridge, release button 46 (see FIGS. 1 and 2) is pressed down in a direction generally perpendicular to the axis of pivot 24. This frees the snap connector 38 from engagement with the lip 41 of the tool. The blade cartridge 34 may then slide forward from the front of the tool, disengaging the dovetail connection 36. A new blade cartridge may then be installed.

When the coaxial cable is properly seated in V-shaped guide 32, the blade 16 is perpendicular to the axis of the coaxial cable and rotation of the tool relative to the coaxial cable produces a clean cut surface on the inner insulating layer that is perpendicular to the axis of the coaxial cable. Excess material between the cut and the end of the cable is removed by sliding it off the end.

The second cutting mechanism 14 can now be used to remove the outer insulating layer for a desired adjustable distance from the cut made by the first cutting mechanism to expose a corresponding length of the outer conductor.

Referring to FIG. 2, the second cutting mechanism 14 is substantially cylindrical and is mounted in a corresponding cylindrical opening 60 in handle 28 at the opposite end from the first cutting mechanism. The second cutting mechanism includes a cable-receiving opening 48 having a diameter that matches the diameter of the coaxial cable to be stripped. The cable-receiving opening is parallel to the pivot in the first cutting mechanism.

Referring to FIGS. 2 and 6, a double-edged cutting blade 18 is mounted at an angle to the axis of the cable-receiving opening 48 and extends through an opening 50 into the cable-receiving opening. The double-edged cutting blade 18 includes two cutting edges preferably oriented at 90° to each other that touch at a corner point. One blade edge extends into the cable-receiving opening by a distance that corresponds to the thickness of the outer insulating layer. This blade edge lies in a plane that is approximately parallel to the axis of the coaxial cable and acts to shave and/or lift the outer insulation off of the outer conductor. The second blade edge is perpendicular to the first blade edge and acts to cut off the waste material as the tool is rotated.

As can be seen in FIG. 2, the adjustable stop 54 comprises an axially hollow threaded cylinder with a knurled gripping end 58 and an outer threaded surface. The axis of the opening 52 in the threaded stop 54 is coaxially aligned with the axis of the cable-receiving opening 48

When the coaxial cable is first inserted into the cable-receiving opening 48, the exposed center conductor from the first cutting operation passes underneath the double-edged cutting blade 18 and into opening 52 that extends through threaded adjustable stop 54. Opening 52 preferably extends all the way through stop 54 and allows the cable to enter the receiving opening 48 into cutting contact with cutting blade 18.

As the cable is inserted, it initially brings the cut surface produced by the first cutting mechanism into contact with the corner of the double-edged cutting blade 18. At this point, the outer insulating layer must be cut away for the cable to enter farther into the opening 48. As the tool is rotated relative to the cable, the two edges of the double-edged cutting blade begin making simultaneous shaving and separating cuts. The angle of cutting blade 18, as seen in FIG. 2, causes the vertical cutting edge at the front of the blade 18 to cut into the outer insulating layer and produce a spiral cut that progressively cuts away more of the outer insulation as the tool is rotated.

As the tool continues to turn, waste material is cut away and exits through opening 50. The spiral cutting action causes the coaxial cable to slowly move deeper into the cable-receiving opening 48. Eventually, the cut surface on the inner insulation (produced by the first cutting operation) reaches and contacts stop surface 56, which is located at the end of adjustable stop 54. Stop surface 56 functions to limit the depth that the cable can enter the cutting mechanism and thereby controls the distance that the outer insulating layer is removed beyond the cut produced by the planar cutting blade of the first cutting mechanism.

Stop surface 56 is the flat surface perpendicular to the axis of openings 48 and 52 located at the end of stop 54 and comprises an annular ring around opening 52. When the cut surface on the first insulating layer reaches the stop surface 56, it comes into flush contact with the stop surface 56, which prevents the coaxial cable from entering further into the cable-receiving opening 48. This limits the distance that the outer insulation can be removed by cutting blade 18.

Stop 54 includes an externally threaded surface that fits within a corresponding internally threaded opening 55 in the second cutting mechanism. By rotating the stop 54, the stop surface 56 can be threaded into our out of the threaded opening 55. This moves the stop towards or away from the cutting blade 18 and adjusts the distance that the cable can enter the opening 48. The end of the stop 54 opposite stop surface 56 is knurled to form a knurled gripping surface 58 so that the stop location can be easily adjusted.

By rotating the knurled end counter-clockwise, the stop surface 56 is moved away from the cutting blade 18 and more of the outer insulation is removed before the inner insulation contacts stop surface 56. By rotating the knurled end 58 in the opposite direction, the tool is adjusted to remove less of the outer insulation.

By varying the location of the cut made by the first cutting mechanism, the exposed length of the inner conductor can be varied. By turning the knurled end 58 of the second cutting mechanism, the stop surface 56 is moved and the exposed length of the outer conductor is varied.

The second cutting mechanism 14 is mounted within opening 60 such that the direction the coaxial cable enters the first cutting mechanism at the front of the tool is parallel to the direction the coaxially cable enters the second cutting mechanism. The tool can make the first cut and be shifted to the side to engage the coaxial cable for the second cut.

The jaw set of the first cutting mechanism opens perpendicular to the coaxial cable which allows the planar cutting blade 16 be positioned at any location along the coaxial cable. The second cutting mechanism is open opposite to the cable-receiving opening 48 allowing the inner conductor of the coaxial cable to extend all the way through the second cutting mechanism and out the opposite side through the knurled end of the adjustable stop. The double-edged cutting blade 18 is removable for sharpening and replacement by removing screw 68.

In the most highly preferred embodiment of the invention, in addition to the first and second cutting mechanisms, the tool is provided with an inner conductor cutter 62. Inner conductor cutter 62 acts to remove any sharp edges on the inner conductor that might prevent proper attachment to the connector being installed. The inner conductor cutter preferably is oriented to receive the coaxial cable in a direction that is also parallel to the direction the cable enters the first and second cutting mechanisms.

The inner conductor cutter 62 includes a conical opening 64 with four cutting edges 66 on its inner surface. The four cutting edges 66 cut a bevel on the circumference of the tip of the inner conductor when the tool is rotated. By beveling the tip of the inner conductor, it is more easily inserted into a corresponding opening in the connector to be attached. In the preferred design, the inner conductor cutter 62 is mounted between the first and second cutting mechanisms

While the present invention has been particularly described, in conjunction with a specific preferred embodiment, it is evident that many alternatives, modifications, and variations will be apparent to those skilled in the art in light of the foregoing description. It is therefore contemplated that the appended claims will embrace any such alternatives, modifications, and variations as falling within the true scope and spirit of the present invention.

Thus, having described the invention, what is claimed is:

1. A coaxial cable stripping tool for preparing an end of a coaxial cable for attachment to a connector, the coaxial cable having an outer conductor covered with an outer insulating layer and an inner conductor separated from the outer conductor by an inner insulating layer, the coaxial cable stripping tool comprising:
a first cutting mechanism for cutting to the inner conductor, the first cutting mechanism being located at a first end of the tool; and
a second cutting mechanism for cutting to the outer conductor, the second cutting mechanism being located at a second end of the tool;
the first cutting mechanism comprising:
a first jaw member;
a second jaw member connected to said first jaw member by a pivot to form a jaw set for receiving the coaxial cable therebetween, the first jaw member and second jaw member being biased towards each other and movable with respect to each other about the pivot between an open position to receive the coaxial cable and a closed position to cut the coaxial cable; and
a planar cutting blade mounted to one of the jaw members for cutting through the inner insulating layer to the inner conductor to produce a cut surface on the inner insulating layer perpendicular to the coaxial cable;
the second cutting mechanism comprising:
a cable-receiving opening in the second cutting mechanism for receiving the coaxial cable;
an adjustable stop having a stop surface for contacting the cut surface on the inner insulating layer, the adjustable stop being axially movable relative to the cable-receiving opening; and
a double-edged cutting blade secured to the second cutting mechanism and projecting at an angle into the cable-receiving opening, the double-edged cutting blade spirally cutting into and removing the outer insulating layer from the coaxial cable when the tool is rotated relative to the cable and the stop surface contacting the cut surface on the inner insulating layer when the outer insulating layer has been removed from the end of the coaxial cable to a desired adjustable distance.

2. The coaxial cable stripping tool according to claim 1 wherein the planar cutting blade is mounted in a replaceable blade cartridge that snaps into the first jaw member and is secured therein without separate fasteners.

3. The coaxial cable stripping tool according to claim 2 wherein the replaceable blade cartridge snaps into the first jaw member with a dovetail-shaped connection.

4. The coaxial cable stripping tool according to claim 3 wherein the replaceable blade cartridge is removable from the first jaw member by sliding out of the first jaw in a direction perpendicular to the pivot.

5. The coaxial cable stripping tool according to claim 1 further including an inner conductor cutter for applying a bevel to an end of the inner conductor.

6. The coaxial cable stripping tool according to claim 5 wherein the first and second cutting mechanisms and the inner conductor cutter receive the coaxial cable from parallel directions.

7. The coaxial cable stripping tool according to claim 5 wherein the inner conductor cutter includes a conical opening for receiving an exposed end of the inner conductor.

8. The coaxial cable stripping tool according to claim 5 wherein the inner conductor cutter is mounted between the first and second cutting mechanisms.

9. The coaxial cable stripping tool according to claim 1 wherein the pivot in the first cutting mechanism is parallel to the cable-receiving opening in the second cutting mechanism.

10. The coaxial cable stripping tool according to claim 1 wherein the cable-receiving opening in the second cutting mechanism includes an open end for receiving the coaxial cable and a threaded end for receiving the adjustable stop.

11. The coaxial cable stripping tool according to claim 10 wherein the adjustable stop includes a threaded end engaging the cable-receiving opening and a knurled end for rotating the adjustable stop to vary the distance between the stop surface and the double-edged cutting blade.

12. The coaxial cable stripping tool according to claim 1 wherein:
the jaw set of the first cutting mechanism opens perpendicular to the coaxial cable allowing the planar cutting blade to be positioned at any location along the coaxial cable; and
the second cutting mechanism is open opposite to the cable-receiving opening to allow the inner conductor to extend through the second cutting mechanism as the double-edged cutting spirally removes the outer insulation.

13. The coaxial cable stripping tool according to claim 1 wherein the first cutting mechanism includes a pair of handles for opening the jaw set and the second cutting mechanism is mounted in an opening in one of the pair of handles.

14. The coaxial cable stripping tool according to claim 13 wherein the opening in one of the pair of handles and the second cutting mechanism are substantially cylindrical.

15. The coaxial cable stripping tool according to claim 13 wherein the cable-receiving opening in the second cutting mechanism includes an open end for receiving the coaxial cable and an opposite end for receiving the adjustable stop and wherein the open end of the cable-receiving opening is open to one side of the pair of handles and the adjustable stop extends into the opposite end of the cable-receiving opening from an opposite side of the pair of handles.

16. The coaxial cable stripping tool according to claim 15 wherein the adjustable stop includes a knurled end for rotating the adjustable stop to vary the distance between the stop surface and the double-edged cutting blade, the knurled end of the adjustable stop and the open end of the cable-receiving opening extending to opposite sides of the pair of handles.

17. The coaxial cable stripping tool according to claim 1 wherein the double-edged cutting blade is removable from the second cutting mechanism for sharpening or replacement.

18. The coaxial cable stripping tool according to claim 1 wherein the planar cutting blade is mounted in a replaceable blade cartridge and the first cutting mechanism includes a release button for releasing the replaceable blade cartridge.

19. The coaxial cable stripping tool according to claim 18 wherein the release button is responsive to pressure applied in a direction perpendicular to the pivot to release the replaceable blade cartridge.

20. The coaxial cable stripping tool according to claim 1 wherein the adjustable stop comprises an axially hollow threaded cylinder with a gripping end for threadedly rotating the adjustable stop to vary the distance between the stop surface and the double-edged cutting blade, an end opposite the gripping end having an annular flat surface forming the stop surface for contacting the cut surface of the inner insulating layer to stop the second cutting mechanism when the outer insulating layer has been removed from the end of the coaxial cable to the desired adjustable distance.
